(19) United States
(12) Patent Application Publication
(10) Pub. No.: US 2016/0200214 A1
(43) Pub. Date: Jul. 14, 2016

(54) BATTERY PACK AND ELECTRIC VEHICLE

(71) Applicant: SONY CORPORATION, Tokyo (JP)

(72) Inventors: Yoshihito ISHIBASHI, Tokyo (JP); Rui KAMADA, Tokyo (JP); Kazuo NAGAI, Kanagawa (JP)

(21) Appl. No.: 14/913,751

(22) PCT Filed: Jul. 30, 2014
(86) PCT No.: PCT/JP2014/003978

§ 371 Date: Feb. 23, 2016

(30) Foreign Application Priority Data
Sep. 2, 2013 (JP) 2013-181197

(51) Int. Cl. B60L 11/18

(52) U.S. Cl. CPC B60L 11/1868; B60L 11/1861

(57) ABSTRACT

A battery apparatus and an electric vehicle including the battery apparatus are provided. The battery apparatus including a first battery module and a second battery module that are connected in parallel and have different characteristics, wherein a first maximum output voltage of the first battery module is set to be larger than a second maximum output voltage of the second battery module, and a first use range of the first battery module is set to differ from a second use range of the second battery module.

### CROSS REFERENCE TO RELATED APPLICATIONS

This application claims the benefit of Japanese Priority Patent Application JP 2013-181197 filed on Sep. 2, 2013, the entire contents of which are incorporated herein by reference.

### TECHNICAL FIELD

The present disclosure relates to a battery apparatus and an electric vehicle.

### BACKGROUND ART

In recent years, a battery apparatus that uses a plurality of single batteries, each of which is a light weight, high capacity secondary battery, is used as a power source of an electronic device. A battery is used as a driving power not only in the electronic device but also in an electrically driven bicycle, an electric motorcycle, and industrial apparatuses such as a fork lift, for purposes of replacing fuel with substances other than petroleum, and reduction of carbon dioxide.

Further, a battery apparatus that uses a plurality of single batteries, each of which is a light weight, high capacity secondary battery, is used also as a vehicle driving power source of an EV (Electric Vehicle), an HEV (Hybrid Electric Vehicle), a PHEV (Plug-in Hybrid Electric vehicle), and the like. The PHEV is a vehicle that charges the secondary batteries of the hybrid electric vehicle by a household power, and is capable of driving a certain distance as an electric vehicle. Especially, lithium ion secondary batteries that are compact, lightweight, and have high energy density are suitable for vehicle-mounted batteries.

For example, the patent document 1 below describes a battery apparatus that is used in an electric vehicle or in a hybrid electric vehicle, and that connects a high output density type secondary battery and a high energy density type secondary battery in parallel.

### CITATION LIST

### Patent Literature

PTL 1: JP 2004-111242 A

### SUMMARY

### Technical Problem

In the technique described in the patent document 1, normally electric power is supplied to a load from the high output density type secondary battery. Due to this, there was a problem that the high output density type secondary battery is deteriorated. Accordingly, it is desirable to provide a battery apparatus and an electric vehicle that can solve the above problem.

### Solution to Problem

In order to solve the aforementioned problems, there is provided in the present disclosure, for example, a battery apparatus including a first battery module and a second battery module that are connected in parallel and have different characteristics, wherein a maximum output voltage of the first battery module is set to be larger than a maximum output voltage of the second battery module, and a use range of the first battery module is set to differ from a use range of the second battery module.

The present disclosure includes, for example, an electric vehicle including: a battery apparatus including a first battery module and a second battery module that are connected in parallel and have different characteristics, wherein a maximum output voltage of the first battery module is set to be larger than a maximum output voltage of the second battery module, and a use range of the first battery module is set to differ from a use range of the second battery module; and a drive unit to which electric power is supplied at least from one of the first battery module and the second battery module.

The present disclosure includes, for example, a battery apparatus and an electric vehicle including a battery apparatus. The battery apparatus including a first battery module and a second battery module that are connected in parallel and have different characteristics, wherein a first maximum output voltage of the first battery module is set to be larger than a second maximum output voltage of the second battery module, and a first use range of the first battery module is set to differ from a second use range of the second battery module.

### Advantageous Effects of Invention

According to at least one embodiment, the battery modules used in the battery apparatus can be prevented from being deteriorated. Notably, the advantageous effects described herein are not necessarily limited, and may be any of the advantageous effects described in the present disclosure. Further, contents of the present disclosure are not to be construed limitedly by the advantageous effects exemplified below.

### BRIEF DESCRIPTION OF DRAWINGS

FIG. 1 is a diagram for explaining an example of a discharge characteristic of first battery cells in one embodiment.

FIG. 2 is a diagram for explaining an example of a charge characteristic of second battery cells in one embodiment.

FIG. 3 is a diagram for explaining an example of a discharge characteristic of the second battery cells in one embodiment.

FIG. 4 is a block diagram for explaining an example of a configuration of an electric vehicle to which a battery apparatus is applied in one embodiment.

FIG. 5 is a diagram for explaining an example of a configuration of an electric power I/F in one embodiment.

FIG. 6 is a diagram for explaining an example of a configuration of a first battery module in one embodiment.

FIG. 7 is a diagram for explaining an example of a configuration of a second battery module in one embodiment.

FIG. 8 is a diagram for explaining an example of an operation of the battery apparatus in one embodiment.

FIG. 9 is a flow chart for explaining an example of a charge control in the battery apparatus of one embodiment.

FIG. 10 is a diagram for explaining a variation.

FIG. 11 is a diagram for explaining a variation.

### DESCRIPTION OF EMBODIMENTS

Hereinbelow, one embodiment of the present disclosure will be described with reference to the drawings. Explanation will be made in the following order.

### <1. One Embodiment>

### <2. Variations>

Embodiments explained hereinbelow are suitable specific examples of the present disclosure, and contents of the present disclosure are not limited to these embodiments.

### 1. One Embodiment

One example of battery modules used in a battery apparatus

Firstly, an example of battery modules used in a battery apparatus in one embodiment of the present disclosure will be explained. Details will be described later, and the battery apparatus in one embodiment includes a first battery module and a second battery module. The first battery module includes a first battery cell unit configured of one or more first secondary battery cells, and the second battery module includes a second battery cell unit configured of one or more second secondary battery cells. The first battery module and the second battery module are connected in parallel, for example.

The first battery module and the second battery module respectively have different characteristics. As such characteristics, the number of times of repeating charge/discharge, size and weight of the battery module itself, and a full charge voltage of the secondary battery cells that each of the battery modules have may be exemplified.

Notably, the number of times of repeating charge/discharge is defined by a number of times of charge/discharge when a retainable electric capacity reaches a value equal to or less than a predetermined value of a nominal capacity (for example, 80%) while repeating charge and discharge, for example, in a range of 0 to 100% of the nominal capacity (which may be another range, for example, 10% to 90%). The number of times of repeating charge/discharge in some cases is termed as a cycle length (cycle number).

Notably, the number of times of repeating charge/discharge is defined by different contents depending on cases in accordance with types of batteries, a device to be used for the charge and discharge, definition by respective manufacturers, and conditions of charge/discharge tests and the like. In one embodiment, the number of times of repeating charge/discharge of the first battery module and the number of times of repeating charge/discharge of the second battery module simply need to be defined by the same content, and the number of times of repeating charge/discharge is not limited to a specific content.

The first battery module in one embodiment has a characteristic that the number of times of repeating charge/discharge is larger than the second battery module. On the other hand, it has characteristics that its size of the battery module is large compared to the second battery module, the weight of the battery module is large compared to the second battery module, and a full charge voltage of the first secondary battery cells is smaller than a full charge voltage of the second secondary battery cells.

The second battery module in one embodiment has a characteristic that the number of times of repeating charge/discharge is smaller than the first battery module. On the other hand, it has characteristics that its size of the battery module is small compared to the first battery module, the weight of the battery module is small compared to the first battery module, and the full charge voltage of the second secondary battery cells is larger than the full charge voltage of the first secondary battery cells.

In showing one example, the number of times of repeating charge/discharge of the first battery module is several thousand times to ten thousand times or so, whereas the number of times of repeating charge/discharge of the second battery module is several hundred times to a thousand times or so. The full charge voltage of the first secondary battery cells of the first battery module is 3.6 V (volts), whereas the full charge voltage of the second secondary battery cells of the second battery module is 4.2 V.

As the first secondary battery cells having the aforementioned characteristics, lithium ion secondary batteries containing a positive electrode active material having an olivine structure as a positive electrode material can be exemplified. The positive electrode active material having the olivine structure specifically includes a lithium iron phosphate compound (LiFePO₄), or lithium iron complex phosphate compound (LiFeₓM₁₋ₓO₄: where M is one or more types of metal, and x satisfies 0<x<1) containing heteroatoms. In a case where M is two types or more, selection is made such that a total sum of respective subscripted numbers becomes 1-x.

As M, transition elements, group IIA elements, group IIIA elements, group IIIB elements, group IVB elements may be exemplified. Especially, it is preferable to include at least one type of element selected from a group of cobalt (Co), nickel, manganese (Mn), iron, aluminum, vanadium (V), and titanium (Ti).

The positive electrode active material may have a coating layer containing metal oxides (for example, metal oxides selected from Ni, Mn, Li and the like), or phosphate compound (for example, lithium phosphate) and the like having different composition from the aforementioned oxide on a surface of the lithium iron phosphate compound or the lithium iron complex phosphate compound.

As a negative electrode active material, no specific limitation is made, however, carbon material such as graphite, lithium titanate, silicon (Si) containing material, tin (Sn) containing material and the like can be exemplified.

Notably, in the following explanation, the explanation will be given on the premise that lithium iron phosphate compound (LiFePO4) is used as the positive electrode material of the first secondary battery cells. The first secondary battery cells will suitably be termed battery cells LFP, and the first battery module including one or more battery cells LFP will suitably be termed a battery module LFPM.

As the second secondary battery cells having the aforementioned characteristics, lithium ion secondary batteries that contain lithium composite oxides such as active materials of ternary system (LiNiₓMn_{y}Co_{z}O₂ (x+y+z=1)), lithium cobalt oxide (LiCoO₂) having a laminar evaporitic structure, lithium nickel oxide (LiNiO₂), lithium manganese oxide (LiMnO₂), lithium manganese oxide having a spinel structure (LiMn₂ O₄), and the like as the positive electrode material can be exemplified.

As a negative electrode active material, no specific limitation is made, however, carbon material such as graphite, lithium titanate, silicon (Si) containing material, tin (Sn) containing material and the like can be exemplified.

Notably, in the following explanation, the explanation will be given on the premise that the active material of the ternary system is used as the positive electrode material of the second secondary battery cells. The second secondary battery cells will suitably be termed battery cells LIB, and the second battery module including one or more battery cells LIB will suitably be termed a battery module LIBM.

Notably, no specific limitation is made as to manufacturing methods of electrodes of the first secondary battery cells and the second secondary battery cells, and methods that are used in the field can widely be used. No specific limitation is made as to electrolytes used in the respective secondary battery cells, and electrolytes either in liquid or gel used in the industrial field can widely be used. Shapes of the respective secondary battery cells may be any of square, cylindrical, or flat plate, and no specific limitation is made hereto.

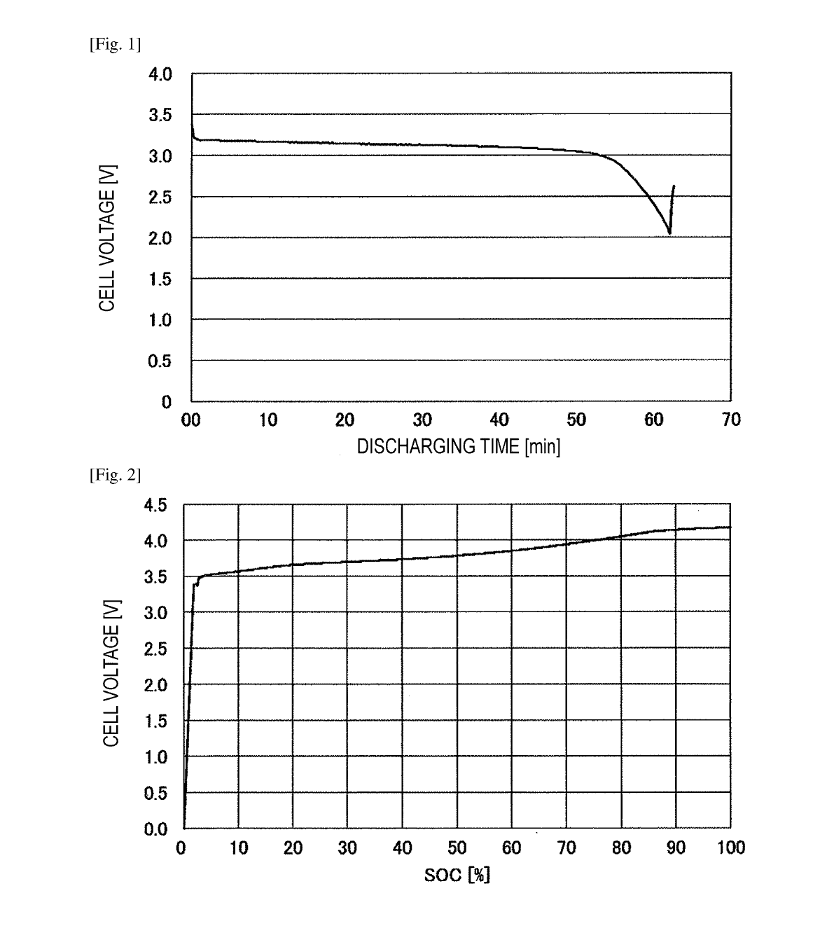

FIG. 1 shows an example of a discharge characteristic of the battery cells LFP. Notably, discharge conditions are set such that a temperature is 25 degrees Celsius, a constant current mode (CC mode), a discharge current is 1C (2.89A (amperes)), and a discharge terminating voltage is 2.5 V. In FIG. 1, a vertical axis indicates a voltage (V) of cells, and a horizontal axis indicates a discharging time (minutes). According to FIG. 1, the voltage of the cells reaches the discharge terminating voltage at about 60 minutes.

FIG. 2 shows an example of a charge characteristic of the battery cells LIB. Notably, charging conditions are set such that a temperature is 25 degrees Celsius, a charging current is 2A, and a terminating voltage is 4.2 V. In FIG. 2, a vertical axis indicates a voltage (V) of the cells, and a horizontal axis indicates a capacity denoted under SOC (State Of Charge)(%). Notably, the SOC is 100% in a fully charged state.

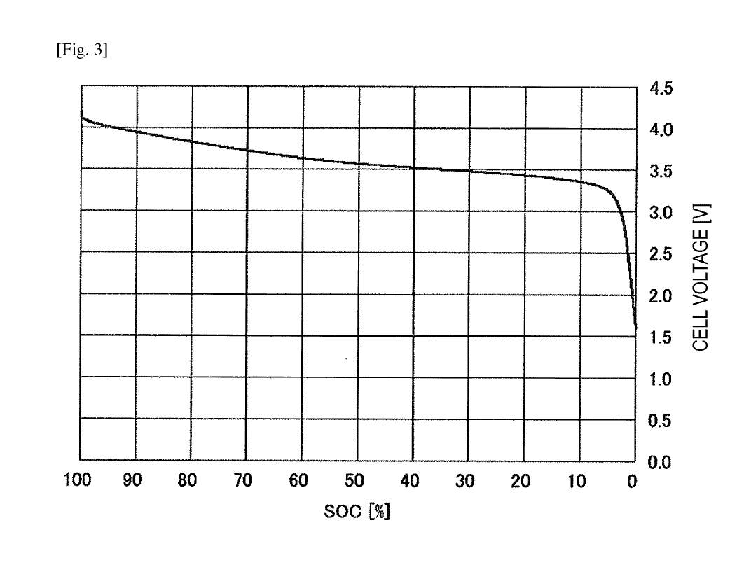

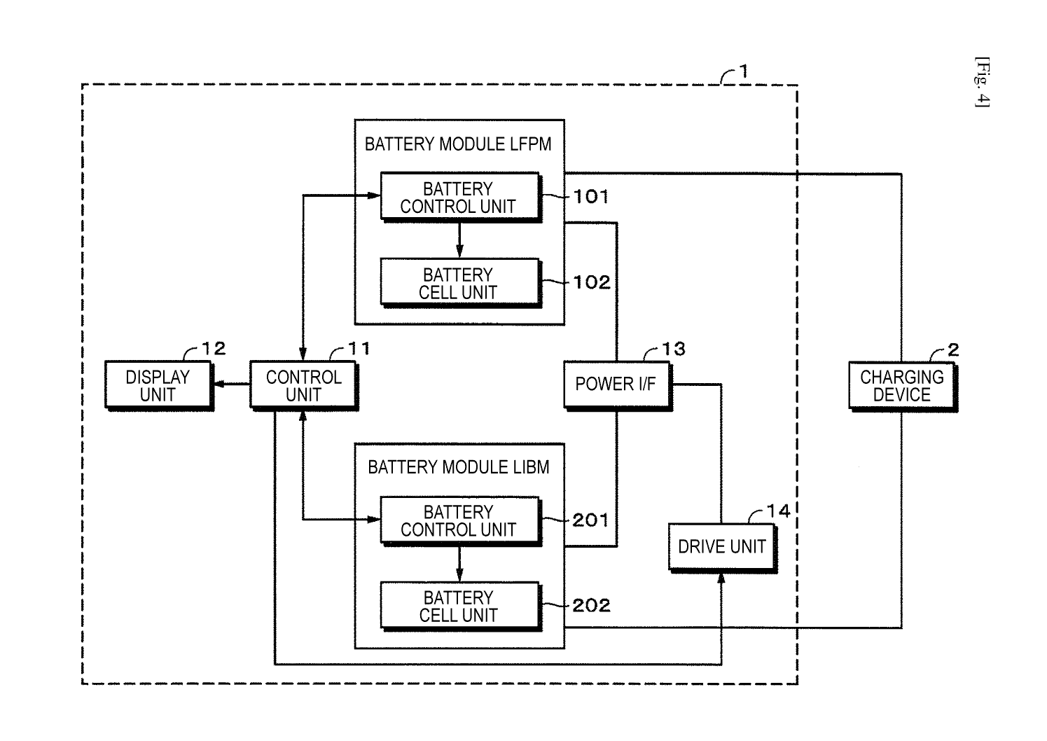

FIG. 3 shows an example of a discharge characteristic of the battery cells LIB. Discharge conditions are set at a temperature 25 degrees Celsius, and a discharge current of 3A. Notably, in the example shown in FIG. 3, discharge is performed to about 1.5 V, however, in actuality, a control to prevent over-discharge is performed at about a predetermined value (for example, 2.7 V). In FIG. 3, a vertical axis indicates a voltage (V) of the cells, and a horizontal axis indicates a remaining amount denoted under the SOC (%).

In using the lithium ion secondary batteries, generally it is preferable to use them by setting a use range (especially, upper limit) at a low level. For example, in charging the battery cells LIB, compared to charging them to their full charge voltage (for example, 4.2 V), stopping the charging at a lower voltage is considered to increase the number of times of repeating charge/discharge. For example, the number of times of repeating charge/discharge increases in the case of setting the upper limit of the use range of the battery cells LIB at 3.7 V to 3.8 (90% or less under the denotation of the SOC, and 60% to 80% in this case) than in the case of setting the same at the full charge voltage. Meanwhile, since the number of times of repeating charge/discharge does not increase so much even in cases where the upper limit is further made lower and use is made in a range of SOC 50% or less, the upper limit of the use range of the battery cells LIB is set in the aforementioned range as an example. Notably, a lower limit of the use range may be set at a value higher than SOC 0% (for example, 20%).

The properties of the lithium ion secondary batteries as aforementioned apply to the battery cells LFP. However, the battery cells LFP have significantly larger number of times of repeating charge/discharge than the battery cells LIB. That is, there is not so much necessity to increase the number of times of repeating charge/discharge by making use in the range of voltages lower than the full charge voltage. Thus, the battery cells LFP are used with the upper limit of the use range set at the full charge voltage (for example, 3.6 V (90% to 100% under the denotation of the SOC)).

One example of configuration of battery apparatus

One example of a configuration of the battery apparatus in one embodiment will be described with reference to FIG. 4. One embodiment is an example in which the battery apparatus is adapted to a small electric vehicle such as an electrically driven bicycle, an electrically driven motorcycle, and the like. An electric vehicle denoted by a reference number 1 in FIG. 4 has a configuration that includes, for example, a battery module LFPM that is an example of a first battery module, a battery module LIBM that is an example of a second battery module, a control unit 11, a display unit 12, an electric power interface (I/F) 13, and a drive unit 14.

As one example, the battery apparatus is configured by the battery module LFPM, the battery module LIBM, and the electric power I/F 13 connecting them. Notably, in FIG. 4 (similarly in FIG. 11 described later), a control flow is shown by an arrow, and an electric power system is shown by a solid line.

The battery module LFPM has a configuration that includes a battery control unit 101, and a battery cell unit 102.

The battery module LIBM has a configuration that includes a battery control unit 201, and a battery cell unit 202. Notably, details of the configuration of each of the battery modules will be described later.

The control unit 11 is configured, for example, of a CPU (Central Processing Unit), and controls respective units of the electric vehicle 1. The control unit 11 can perform, for example, a bidirectional communication with both the battery control unit 101 and the battery control unit 201. As a result of the communication, the control unit 11 controls the display unit 12 as necessary, and notifies a user of the electric vehicle 1 a remaining capacity, warning, and the like via the display unit 12.

Notably, the electric power for the control unit 11 may be supplied from any of the battery module LFPM and the battery module LIBM. Preferably, the electric power is supplied from the battery module LFPM to the control unit 11.

The display unit 12 is configured, for example, of a panel such as a LCD (Liquid Crystal Display), or an organic EL (Electroluminescence) panel, and a driver that drives the panel. The display unit 12 may be configured of a plurality of LEDs (Light Emitting Diodes). The display unit 12 displays various types of information related to the electric vehicle 1 and information, warning, and the like related to the battery modules in accordance with the control of the control unit 11.

Notably, the electric vehicle 1 may have a configuration for outputting sound such as a speaker, and the various types of information may be given notice of to the user by audio.

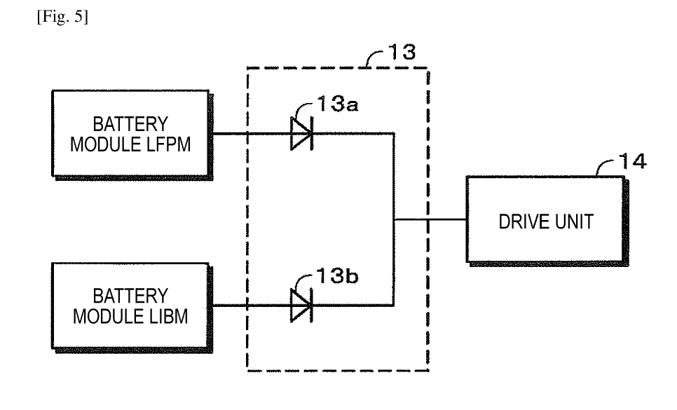

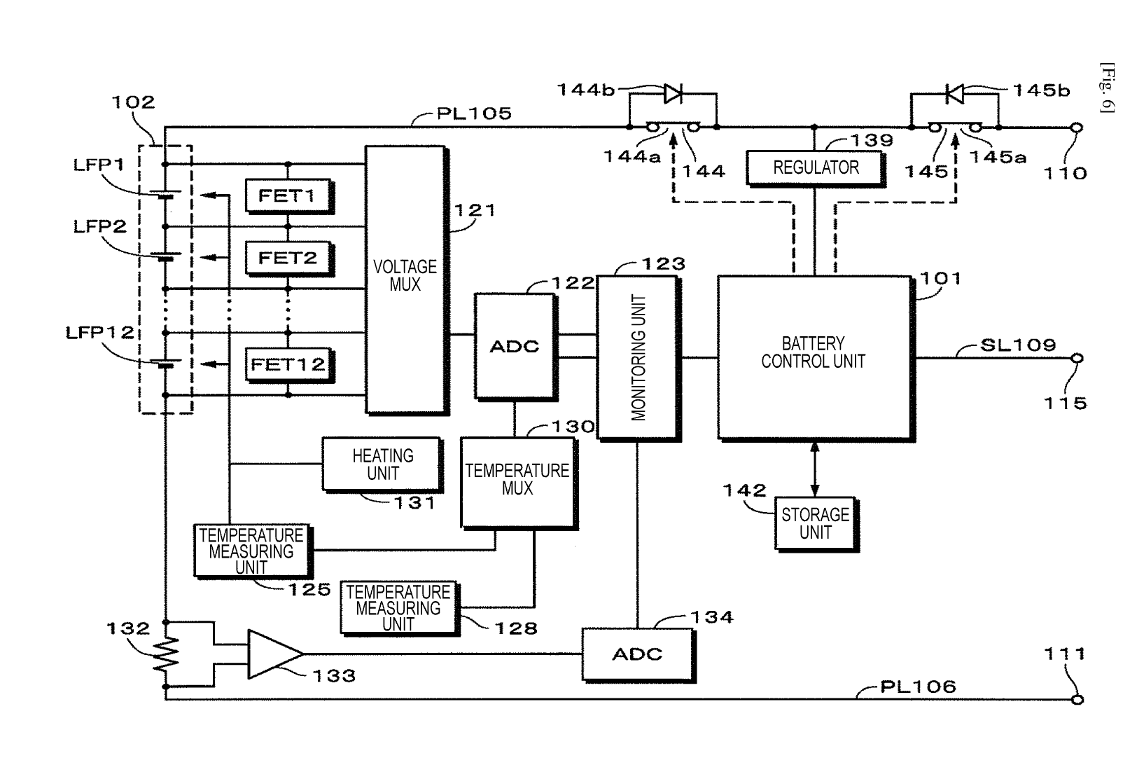

The electric power OF 13 connects the battery module LFPM and the battery module LIBM in parallel, and supplies electric power supplied from at least one of the battery module LFPM and the battery module LIBM to the drive unit 14. The electric power I/F 13 includes, for example, two diodes (diode 13a and diode 13b). As exemplified in FIG. 5, the battery module LFPM and the battery module LIBM are connected by diode OR connection by the diode 13a and the diode 13b.

Although details will be described later, in one embodiment, normally a voltage of the battery module LFPM is set to be high. Due to this, the electric power is supplied from the battery module LFPM to the drive unit 14. When the voltage of the battery module LFPM gradually decreases and substantially matches a voltage of the battery module LIBM, the electric power from the battery module LIBM, or composite electric power that combines the electric power of the battery module LFPM and the battery module LIBM is supplied to the drive unit 14.

The drive unit 14 includes a configuration including a motor and the like that provides drive power. The drive unit 14 operates, for example, in accordance with control by the control unit 11. Aside from the control unit 11, a drive control unit for controlling the drive unit 14 may be provided. Wheels and the like that are not shown are attached to the drive unit 14, and the wheels rotate by the drive unit 14 being operated.

A charging device 2 becomes capable of being connected to the electric vehicle 1 having the exemplified configurations as above. The charging device 2 is a device, for example, that converts commercial electric power into an appropriate voltage, to charge the battery module LFPM and the battery module LIBM. Notably, communication may be performed between the control unit 11 of the electric vehicle 1 and a control unit of the charging device 2 to perform authentication process and the like. Further, the battery modules may be charged by being detached from the electric vehicle 1. In this case, the control unit in the charging device 2 may communicate with the battery control units to perform charge control and authentication process.

One example of configuration of battery module

Respective units configuring the battery module LFPM are, for example, stored in an outer case having a predetermined shape. The outer case preferably uses a material having high conductivity and emissivity. By using the material having the high conductivity and emissivity, a superior heat diffusing performance of the outer case can be obtained. By obtaining the superior heat diffusing performance, a temperature increase in the outer case can be suppressed. Further, an opening of the outer case can be minimized, or eliminated, whereby high dust-proof and water-proof performances can be realized.

For example, the outer case uses a material such as aluminum, aluminum alloy, copper, copper alloy and the like. The same applies to the battery module LIBM.

Further, the battery module LFPM and the battery module LIBM are housed in a body of the electric vehicle 1.

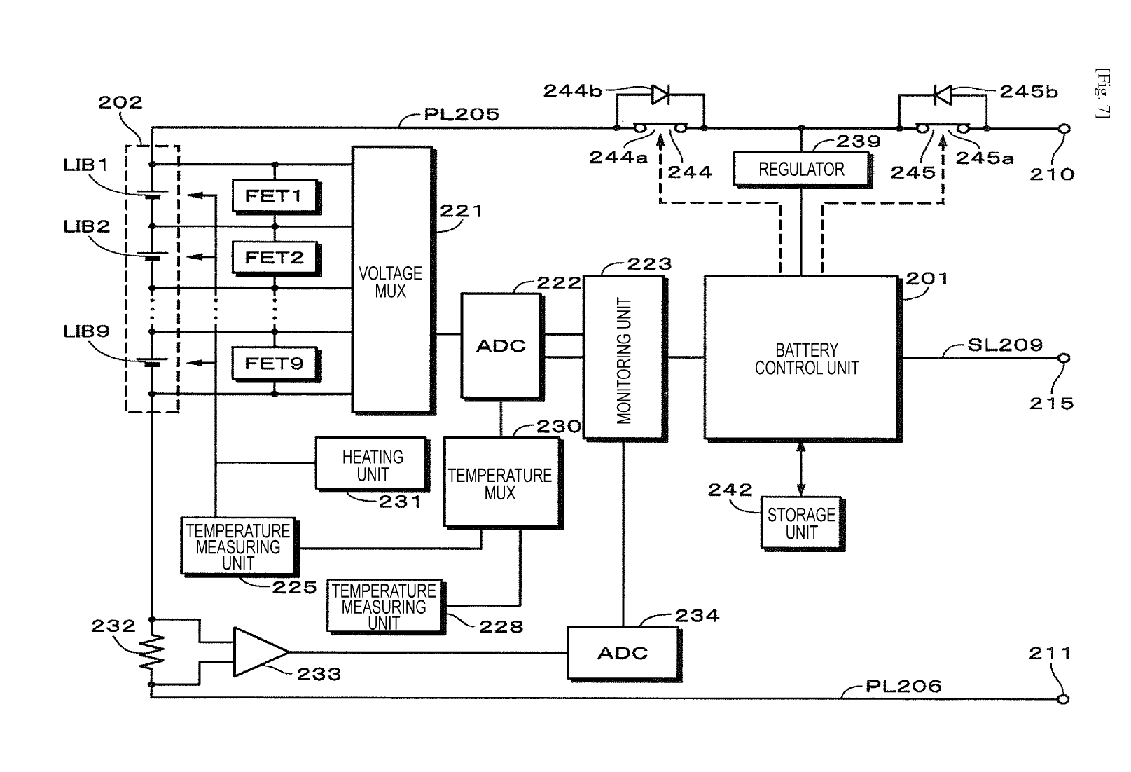

FIG. 6 shows an example of the configuration of the battery module LFPM. The battery module LFPM includes battery cell unit 102 formed of one or more battery cells LFP. In this example, twelve battery cells LFP (battery cell LFP1, battery cell LFP2, . . . , battery cell LFP12) configure the battery cell unit 102. In one embodiment, the twelve battery cells LFP are connected serially.

Notably, a number and connection arrangement of the battery cells can be changed suitably in accordance with purposes of the battery module. For example, the plurality of battery cells LFP may be connected in parallel. Further, sets of the plurality of battery cells LFP being connected in parallel (which may be referred to as a sub module) may be connected serially.

A range of an output voltage (which is suitably referred to as an operation range) of the battery module LFPM is determined in accordance with the voltage and number of the battery cells LFP. For example, when a lower limit of a use region of the battery cells LFP is set to 2.0 V and an upper limit to 3.6 V, 24.0 V to 43.2 V becomes the operation range of the battery module LFPM due to twelve battery cells LFP being connected serially. The maximum output voltage of the battery module LFPM that is the maximum value of the operation range becomes 43.2 V.

A positive electric power line PL105 extends from a positive electrode side of the battery cell LFP1. A positive electrode terminal 110 is connected to the electric power line PL105. A negative electric power line PL106 extends from a negative electrode side of the battery cell LFP12. A negative terminal 111 is connected to the electric power line PL106. The electric power of the battery cell unit 102 is supplied to the drive unit 14 through the positive electric power line PL105 and the negative electric power line PL106.

The battery module LFPM includes a communication line SL109 for communicating with an external device. A communication terminal 115 is connected to the communication line SL109. A bidirectional communication based on a predetermined communication standard is performed between the battery control unit 101 and the control unit 11 through the communication line SL109. As the predetermined communication standard, for example, standards such as I2C which is a standard for a serial communication, and standards such as a SMBus (System Management Bus), a SPI (Serial Peripheral Interface), a CAN, and the like are exemplified. Notably, the communication may be wired, or may be wireless.

The battery module LFPM has a configuration that includes a voltage multiplexer (MUX)121, an ADC (Analog to Digital Converter) 122, a monitoring unit 123, a temperature measuring unit 125, a temperature measuring unit 128, a temperature multiplexer 130, a heating unit 131, a current detection resistance 132, a current detection amplifier 133, an ADC 134, a regulator 139, a storing unit 142, a charge control unit 144, and a discharge control unit 145, other than the aforementioned battery control unit 101 and battery cell unit 102. Further, a FET (Field Effect Transistor) is provided corresponding to each of the battery cells LFP.

The battery control unit 101 controls respective units of the battery module LFPM. The battery control unit 101 performs control related to, for example, the battery cell unit 102. As the control related to the battery cell unit 102, control for monitoring temperature and voltage of the respective battery cells LFP configuring the battery cell unit 102, and current and the like flowing in the battery cell unit 102, control for calculating the SOC of the respective battery cells LFP, controls for ensuring safety of the battery module LFPM such as for the purpose of preventing overcurrent and over-discharge and the like, and control for achieving cell balance of the respective battery cells LFP configuring the battery cell unit 102 may be exemplified.

Notably, various methods can be adapted to a method for calculating the SOC. For example, a discharge curve indicating a relationship of the voltage and the SOC of the battery cells LFP is stored in advance, and the SOC corresponding to the measured voltage of the battery cell LFP may be obtained by using the discharge curve.

Further, a method that obtains the SOC by integrating a charging current and a discharge current to predict a remaining amount of the battery cell LFP (which is referred also as a Coulomb Counter Method) may be adapted. The SOC may be corrected according to operation environments such as environmental temperature, and time-related deterioration.

The voltage multiplexer 121 outputs the voltages of the respective battery cells LFP detected by a voltage detecting unit (omitted from drawings) to the ADC 122. The voltages of the respective battery cells LFP are detected at a predetermined cycle, irrelevant to being charged or discharged. For example, the voltages of the respective battery cells LFP are detected by the voltage detecting unit at a cycle of 250 ms (milliseconds). In this example, since the battery cell unit 102 is configured of twelve battery cells LFP, twelve pieces of analog voltage data are supplied to the voltage multiplexer 121.

The voltage multiplexer 121 switches channels at a predetermined cycle, and selects one analog voltage data from among the twelve pieces of analog voltage data. The one analog voltage data selected by the voltage multiplexer 121 is supplied to the ADC 122. Then, the voltage multiplexer 121 switches the channel, and supplies the subsequent analog voltage data to the ADC 122. Notably, the channel switching by the voltage multiplexer 121 is, for example, controlled by the battery control unit 101.

The temperature measuring unit 125 detects temperatures of the respective battery cells LFP. The temperature measuring unit 125 is formed of elements for detecting temperature such as thermistors and the like. The temperatures of the respective battery cells LFP are detected, for example, at a predetermined cycle, irrelevant to being charged or discharged. Notably, the highest temperature among the twelve pieces of battery cells LFP may be set as the temperature to be output from the temperature measuring unit 125, or an average of the temperatures of the twelve pieces of battery cells LFP may be set as the temperature to be output from the temperature measuring unit 125.

Analog temperature data indicating the temperature of the respective battery cells LFP detected by the temperature measuring unit 125 is supplied to the temperature multiplexer 130. In this example, since the battery cell unit 102 is configured of the twelve pieces of battery cells LFP, twelve pieces of analog temperature data are supplied to the temperature multiplexer 130.

The temperature multiplexer 130 switches channels, for example, at a predetermined cycle, and selects one analog temperature data from among the twelve pieces of analog temperature data. The one analog temperature data selected by the temperature multiplexer 130 is supplied to the ADC 122. Then, the temperature multiplexer 130 switches the channel, and supplies the subsequent analog temperature data to the ADC 122. Notably, the channel switching by the temperature multiplexer 130 is controlled, for example, by the battery control unit 101.

The temperature measuring unit 128 measures a temperature of the entire battery module LFPM. The temperature inside the outer case of the battery module LFPM is measured by the temperature measuring unit 128. Analog temperature data measured by the temperature measuring unit 128 is supplied to the temperature multiplexer 130, and is supplied from the temperature multiplexer 130 to the ADC 122. Then, the analog temperature data is converted to digital temperature data by the ADC 122.

The digital temperature data is supplied from the ADC 122 to the monitoring unit 123.

The ADC 122 converts the analog voltage data supplied from the voltage multiplexer 121 to digital voltage data. The ADC 122 converts the analog voltage data, for example, to the digital voltage data of 14 to 18 bits. As a conversion method in the ADC 122, various types of methods such as a sequential comparison method, a (digital sigma) method and the like can be adapted.

The ADC 122 includes, for example, an input terminal, an output terminal, a control signal input terminal to which a control signal is input, and a clock pulse input terminal to which a clock pulse is input (notably, depiction of these terminals is omitted). The analog voltage data is input to the input terminal. The converted digital voltage data is output from the output terminal.

A control signal (control command) supplied from the battery control unit 101 is input to the control signal input terminal, for example. The control signal is, for example, an acquisition instructing signal that instructs acquisition of the analog voltage data supplied from the voltage multiplexer 121. When the acquisition instructing signal is input, the analog voltage data is acquired by the ADC 122, and the acquired analog voltage data is converted to the digital voltage data. Then, the digital voltage data is output via the output terminal in accordance with a clock pulse for synchronization input to the clock pulse input terminal. The output digital voltage data is supplied to the monitoring unit 123.

Further, an acquisition instructing signal that instructs acquisition of the analog temperature data supplied from the temperature multiplexer 130 is input to the control signal input terminal. The ADC 122 acquires the analog temperature data in accordance with the acquisition instructing signal. The acquired analog temperature data is converted to the digital temperature data by the ADC 122. The analog temperature data is converted to the digital temperature data, for example, of 14 to 18 bits.

The converted digital temperature data is output via the output terminal, and the output digital temperature data is supplied to the monitoring unit 123. Notably, in a configuration, ADCs for respectively processing the voltage data and the temperature data may be provided independently.

For example, twelve pieces of digital voltage data and twelve pieces of digital temperature data are sent from the ADC 122 to the monitoring unit 123 by being time division multiplexed. An identifier that identifies the respective battery cells LFP may be described in a header of transmission data, and indication may be made as to the battery cell LFP of which voltage and temperature are being sent. Notably, although the explanation is given with a single ADC 122 used for the measurements of the cell voltage and temperature, separate ADCs may be used.

The current detection resistance 132 detects values of currents flowing in the twelve pieces of battery cells LFP. Analog current data is detected by the current detection resistance 132. The analog current data is, for example, detected at a predetermined cycle, irrelevant to being charged or discharged.

The current detection amplifier 133 amplifies the detected analog current data. A gain of the current detection amplifier 133 is set, for example, at about 50 to 100 times or so. The analog current data amplified by the current detection amplifier 133 is supplied to the ADC 134.

The ADC 134 converts the analog current data supplied from the current detection amplifier 133 to digital current data. The analog current data is converted to the digital current data, for example, of 14 to 18 bits by the ADC 134. As a conversion method in the ADC 134, various types of methods such as the sequential comparison method, the (digital sigma) method and the like can be adapted.

The ADC 134 includes, for example, an input terminal, an output terminal, a control signal input terminal to which a control signal is input, and a clock pulse input terminal to which a clock pulse is input (depiction of these terminals is omitted). The analog current data is input to the input terminal. The digital current data is output from the output terminal.

A control signal (control command) supplied from the battery control unit 101 is input to the control signal input terminal of the ADC 134, for example. The control signal is, for example, an acquisition instructing signal that instructs acquisition of the analog current data supplied from the current detection amplifier 133. When the acquisition instructing signal is input, the analog current data is acquired by the ADC 134, and the acquired analog current data is converted to the digital current data. Then, the digital current data is output from the output terminal in accordance with a clock pulse for synchronization input to the clock pulse input terminal. The output digital current data is supplied to the monitoring unit 123. Notably, the ADC 122 and the ADC 134 may be configured by the same ADC.

The monitoring unit 123 outputs the digital voltage data and the digital temperature data supplied from the ADC 122 to the battery control unit 101. Further, the monitoring unit 123 outputs the digital current data supplied from the ADC 134 to the battery control unit 101. The battery control unit 101 performs control related to the battery cell unit 102 based on the various types of data supplied from the monitoring unit 123.

The heating unit 131 heats the respective battery cells LFP as necessary. The heating unit 131 is configured, for example, of a resistive wire having a predetermined resistance value, and is provided in the vicinity of the respective battery cells LFP. The resistive wire is arranged within the battery module LFPM such that the respective battery cells LFP can be heated efficiently, and the respective battery cells LFP are heated by flowing current in the resistive wire. Control of the heating unit 131 (for example, on and off of the heating unit 131) is performed, for example, by the battery control unit 101.

The regulator 139 is provided between the electric power line PL105 and the battery control unit 101. The regulator 139 is connected, for example, to a connection midpoint of the charge control unit 144 and the discharge control unit 145. The battery control unit 101 is connected, for example, to the connection midpoint of the charge control unit 144 and the discharge control unit 145 via the regulator 139. The regulator 139 forms a working voltage (for example, 3.3 V or 5 V) of the battery control unit 101 from the voltage of the battery cell unit 102, and supplies the formed working voltage to the battery control unit 101. That is, the battery control unit 101 operates on the electric power of the battery cell unit 102.

The storing unit 142 is configured of a ROM (Read Only Memory), a RAM (Random Access Memory), and the like. The storing unit 142 stores, for example, programs to be executed by the battery control unit 101. The storing unit 142 is further used as a working area upon execution of processes by the battery control unit 101. A history of charges and discharges and the like may be stored in the storing unit 142.

The charge control unit 144 is configured of a charge control switch 144a, and a diode 144b that is connected in parallel with the charge control switch 144a with forward bias relative to the discharge current. The discharge control unit 145 is configured of a discharge control switch 145a, and a diode 145b that is connected in parallel with the discharge control switch 145a with forward bias relative to the charging current. As the charge control switch 144a and the discharge control switch 145a, for example, IGBTs (Insulated Gate Bipolar Transistors), and MOSFETs (Metal Oxide Semiconductor Field Effect Transistors) can be used. Notably, the charge control unit 144 and the discharge control unit 145 may be inserted to the negative electric power line PL106.

On/off controls of the charge control switch 144a and the discharge control switch 145a are performed, for example, by the battery control unit 101. In FIG. 6, a flow of control signals from the battery control unit 101 to the charge control switch 144a and the discharge control switch 145a are indicated by dotted arrows.

An example of the controls of the charge control switch 144a and the discharge control switch 145a will be explained. In a case of charging the battery module LFPM, the charge control switch 144a is turned on, and the discharge control switch 145a is turned off. In a case of discharging the battery module LFPM, the charge control switch 144a is turned off, and the discharge control switch 145a is turned on. In a case where the power of the electric vehicle 1 is turned off, both the charge control switch 144a and the discharge control switch 145a are turned off.

Twelve pieces of FETs (FET1, FET2 . . . FET12) are provided between terminals of the respective battery cells LFP, corresponding to the configuration of the battery cell unit 102 (twelve pieces of battery cells LFP). The FETs are for performing cell balance control in a passive system, for example. The system of the cell balance control is not limited to the passive system, and a so-called active system, or other well-known systems may be adapted.

The aforementioned configuration of the battery module LFPM is merely an example. A part of the exemplified configuration may be omitted, and a configuration different from the exemplified configuration may be added.

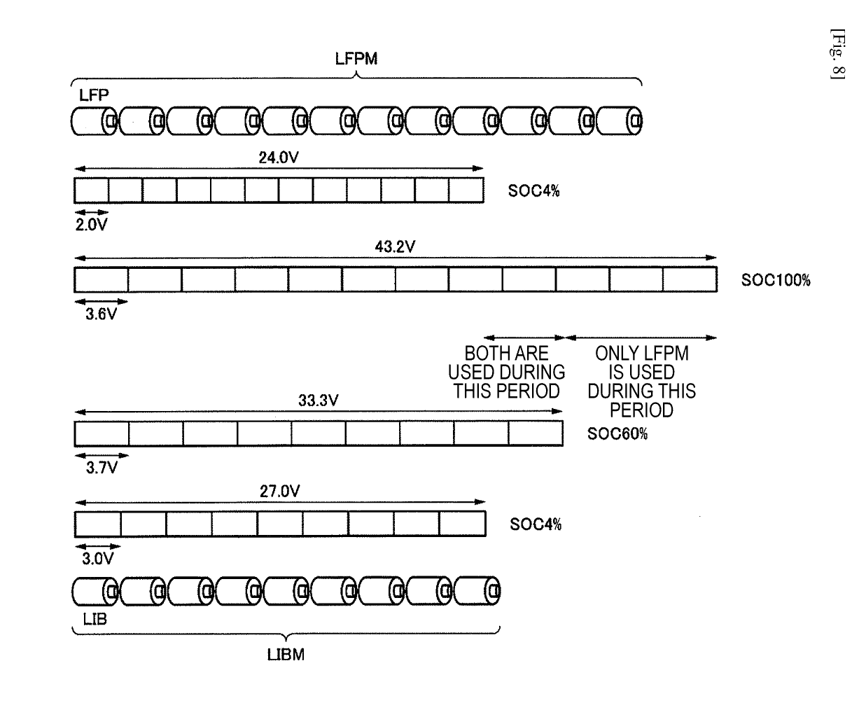

FIG. 7 shows an example of the configuration of the battery module LIBM. The battery module LIBM has, for example, a substantially identical configuration as the battery module LFPM. Hereinbelow, configurations that differ from the configuration of the battery module LFPM will mainly be explained.

The battery module LIBM includes battery cell unit 202 formed of one or more battery cells LIB. In this example, nine battery cells LIB (battery cell LIB1, battery cell LIB2, . . . , battery cell LIB9) configure the battery cell unit 202. In one embodiment, the nine battery cells LIB are connected serially. Notably, a number and connection arrangement of the battery cells can be changed suitably in accordance with purposes of the battery module. For example, the plurality of battery cells LIB may be connected in parallel. Further, sets of the plurality of battery cells LIB that is connected in parallel (which may be referred to as a sub module) may be connected serially.

An operation range of the battery module LIBM is determined in accordance with voltages and a number of the battery cells LIB. For example, when a lower limit of a use region of the battery cells LIB is set to 3.0 V and an upper limit to 3.7 V, 27.0 V to 33.3 V becomes the operation range of the battery module LIBM because nine battery cells LIB are connected serially, and the maximum output voltage of the battery module LIBM that is the maximum value of the operation range becomes 33.3 V.

That is, the maximum output voltage of the battery module LFPM is set to be larger than the maximum output voltage of the battery module LIBM. Further, in considering the use ranges of the respective battery modules in terms of voltages, the use range of the battery module LFPM is in a range, for example, of 24.0 V to 43.2 V, and the use range of the battery module LIBM is in a range, for example, of 24.0 V to 33.3 V, and the use ranges of the two members are configured to differ.

In considering the use range of each battery module being under the denotation of the SOC, an upper limit of the use range of the battery module LFPM is set, for example, to 100% (voltage of 3.6 V), and an upper limit of the use range of the battery module LIBM is set, for example, to 60% (voltage of 3.7 V), and the upper limit of the use range of the battery module LFPM is set to be larger than the upper limit of the use range of the battery module LIBM.

One Example of Discharge Operation

One example of a discharge operation of the battery apparatus will be described with reference to FIG. 8.

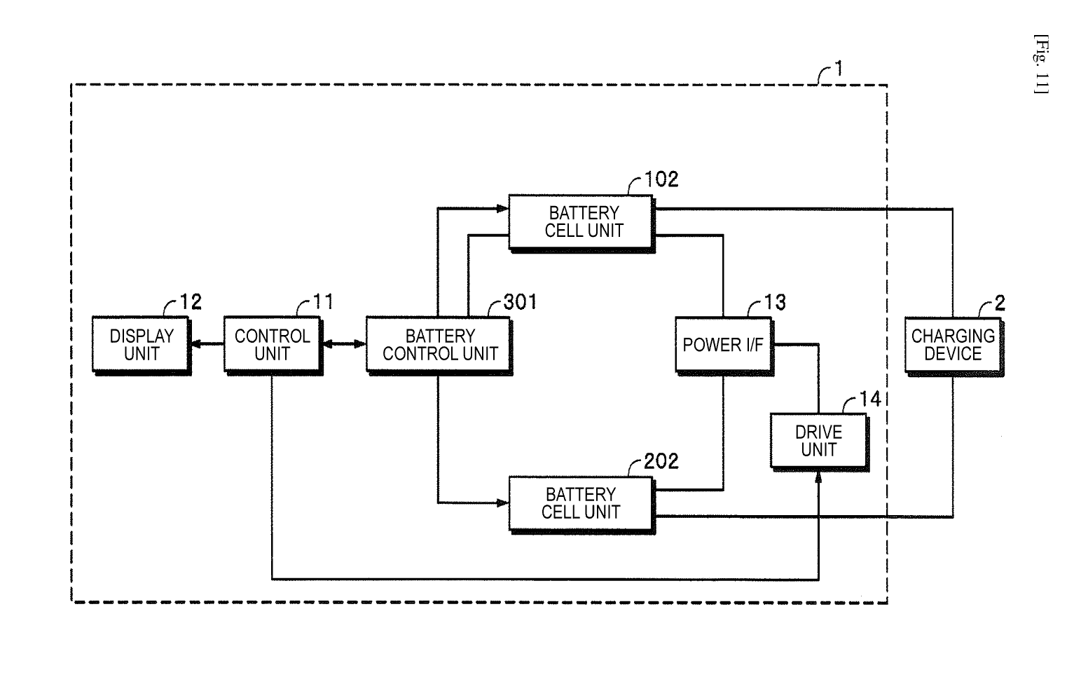

Notably, the explanation will be given on the assumption that, in an initial state of supplying electric power to the drive unit 14, the voltage of the battery module LFPM is 43.2 V, and the voltage of the battery module LIBM is 33.3 V. In FIG. 8 (which applies similarly to FIG. 10 to be described later), the battery cells are schematically shown by cylindrical batteries, and the voltage and the like of the battery cells are schematically shown by square frames.

Since the voltage of the battery module LFPM is larger than that of the battery module LIBM, the output of the battery module LFPM is supplied to the drive unit 14 through the electric power I/F 13. At this stage, the battery module LIBM is not used. The voltage of the battery module LFPM gradually decreases as the electric power is supplied. When the voltage of the battery module LFPM substantially matches the maximum output voltage (which is 33.3 V in this example) of the battery module LIBM, support by the battery module LIBM is performed, whereby the output of the battery module LFPM and the output of the battery module LIBM are combined and supplied to the drive unit 14. Notably, only the output of the battery module LIBM is supplied to the drive unit 14 in some cases.

During when the electric power is supplied to the drive unit 14, the voltages of the battery cells are monitored in each battery module. For example, the voltages of the twelve pieces of battery cells LFP of the battery module LFPM are monitored. In a case where a value of the smallest voltage reaches, for example, 2.0 V among the voltages of the twelve pieces of battery cells LFP, the battery control unit 101 performs control to stop the discharge, and sends a signal indicating as such (which is suitably referred to as a discharge stop signal) to the control unit 11.

Similarly, for example, the voltages of the nine pieces of battery cells LIB of the battery module LIBM are monitored. In a case where a value of the smallest voltage reaches, for example, 3.0 V among the voltages of the nine pieces of battery cells LIB, the battery control unit 201 performs control to stop the discharge, and sends a signal indicating as such (which is suitably referred to as a discharge stop signal) to the control unit 11.

The control unit 11 having received the discharge stop signal from at least one of the battery module LFPM and the battery module LIBM notifies the user of insufficiency of remaining capacity of the battery module. Of course, a process for the control unit 11 to notify the user that the voltage has reached the predetermined SOC may be performed before the remaining capacity becomes insufficient. For example, the control unit 11 performs control to display a warning on the display unit 12, and notifies the user of insufficiency of remaining capacity. The user who had checked the display connects the electric vehicle 1 to the charging device 2 to suitably perform charging.

As above, as one example, the output upon the low voltage state of the battery module LFPM can be supported, and the deterioration of the battery module LIBM can be suppressed by configuring the battery apparatus by connecting the battery module LFPM and the battery module LIBM. Since the upper limit of the use range of the battery module LIBM is set, for example, at about SOC 60%, the number of times of repeating charge/discharge of the battery module LIBM can be increased. Further, if the charging is performed before the output voltage of the battery module LFPM reaches, for example, 33.3 V, the charging of the battery module LIBM does not need to be performed, and the deterioration of the battery module LIBM caused by charging can be prevented. Moreover, the battery module LFPM does not need to be charged by the output electric power of the battery module LIBM.

As one example, by configuring the battery apparatus by connecting the battery module LFPM and the battery module LIBM, the output of the battery module LFPM can be supported by using the battery module LIBM when the SOC of the battery module LFPM decreases. Therefore, for example, similar to control of a motor (such as driving and stopping the motor), a case in which a temporal high output (for example, several ten amperes) is necessary can be handled.

The number of times of repeating charge/discharge of the battery module LFPM is provided with a margin. Because of this, normally, the output voltage of the battery module LFPM is configured to be used, and the battery module LFPM is not significantly deteriorated even if the battery module LFPM is charged frequently. That is, it can be regarded as that hardly any deterioration has occurred in the battery apparatus as a whole.

In a case of configuring the battery apparatus by a plurality of battery modules LFPM, there is a risk that an entirety of the battery apparatus becomes large. However, by configuring the battery apparatus by the battery module LFPM and the compact battery module LIBM, the entirety of the battery apparatus is significantly downsized, and weight can be prevented from becoming heavy. Therefore, the battery apparatus can be used for a compact electric vehicle and the like, and a purpose of use of the battery apparatus can be diversified.

The battery apparatus may be configured of a plurality of battery modules LIBM. However, an upper limit of the number of times of repeating charge/discharge of the battery module LIBM (battery cells LIB) is as many as several hundred times, or a thousand times at most. If the charging takes place several times a day, the battery module LIBM has to be replaced in about a year, and this may cause inconvenience to the user. However, in one embodiment, the battery module used regularly is configured to be the battery module LFPM, and the use range of the battery module LIBM is appropriately set.

Because of this, battery life of the battery module LIBM can be elongated, and the battery module LIBM will not need to be replaced frequently.

One Example of Charge Control

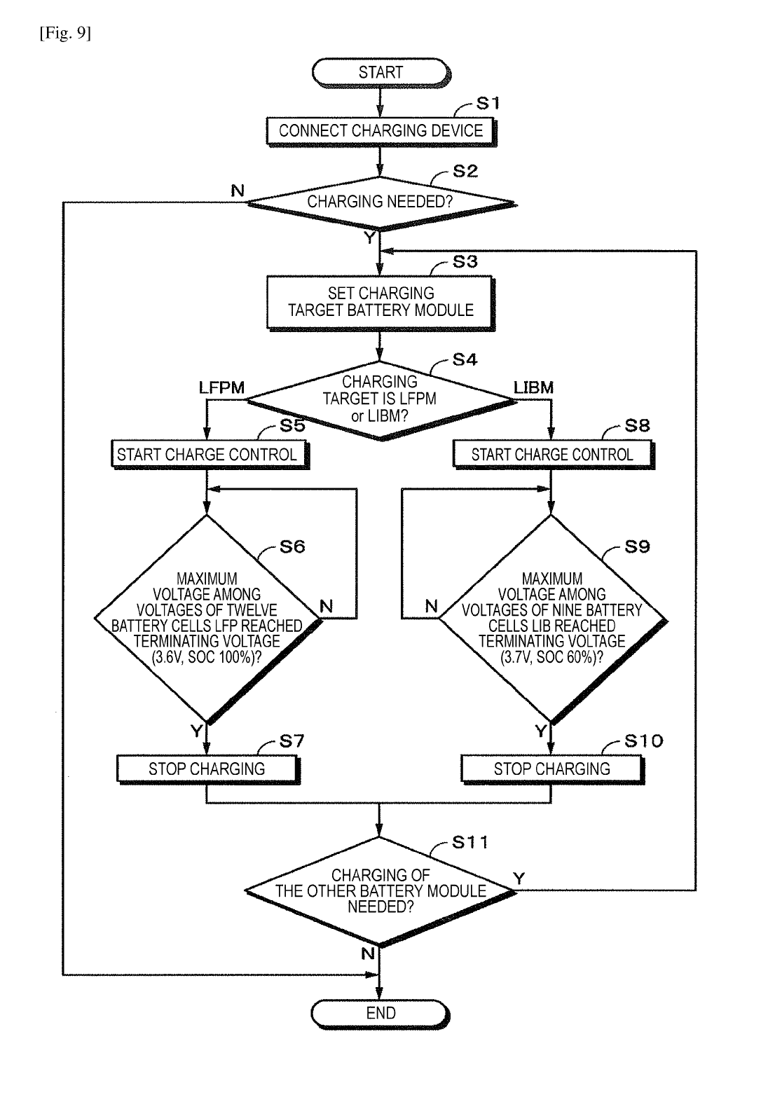

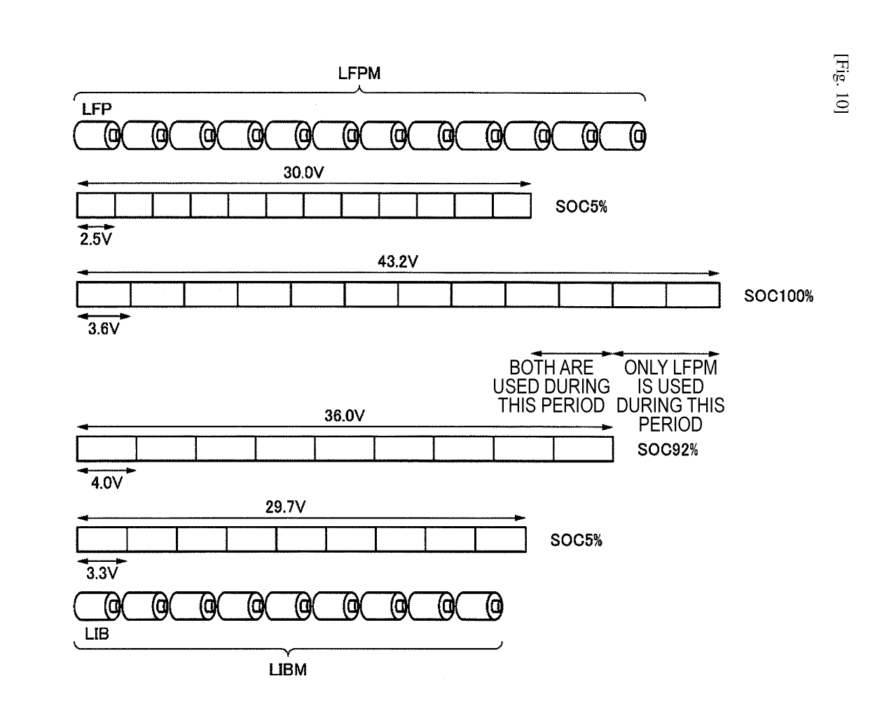

FIG. 9 is a flow chart for explaining one example of a charge control in a battery apparatus. In step S1, the charging device 2 is connected to the electric vehicle 1. The control unit 11 detects that the charging device 2 has been connected to the electric vehicle 1 by a change in a physical connection, or by performing a predetermined communication, for example. Then, the process proceeds to step S2.

In step S2, the control unit 11 inquires whether or not charging is necessary to each of the battery module LFPM and the battery module LIBM. In response to this inquiry, the battery module LFPM notifies the control unit 11 that the charging is necessary in a case where the maximum voltage among the voltages of the twelve pieces of battery cells LFP is smaller than 3.6 V. In response to this inquiry, the battery module LIBM notifies the control unit 11 that the charging is necessary in a case where the maximum voltage among the voltages of the nine pieces of battery cells LIB is smaller than 3.7 V. The control unit 11 determines the necessity of the charging according to the respective responses from the battery module LFPM and the battery module LIBM.

The process ends in a case where a determination is made that the charging is not necessary in step S2. The process proceeds to step S3 in a case where a determination is made that the charging is necessary in step S2.

In step S3, the control unit 11 sets a battery module to be a charging target. That is, control unit 11 instructs the battery control unit of the battery module that is the charging target to charge. Then, the process proceeds to step S4.

In step S4, a determination is made as to whether the battery module that is the charging target is the battery module LFPM or the battery module LIBM. In a case where the battery module that is the charging target is the battery module LFPM, the process proceeds to step S5.

In step S5, the charge control is started in the battery module LFPM, and the charging of the battery module LFPM is conducted. For example, the battery control unit 101 of the battery module LFPM turns on the charge control switch 144a, and turns off the discharge control switch 145a. Then, the process proceeds to step S6. Notably, the charging is conducted, for example, by a CC (constant current)-CV (constant voltage) method.

Monitoring of the voltages of the twelve pieces of battery cells LFP is performed during the charging. In step S6, the battery control unit 101 determines whether or not the maximum voltage among the voltages of the twelve pieces of battery cells LFP has reached a terminating voltage (for example, 3.6 V, SOC 100%). As a result of the determination, in a case where the maximum voltage among the voltages of the twelve pieces of battery cells LFP has not reached the terminating voltage, the process returns to step S6, and the determination of step S6 is repeated. As a result of the determination, in a case where the maximum voltage among the voltages of the twelve pieces of battery cells LFP has reached the terminating voltage, the process proceeds to step S7.

In step S7, control to stop the charging is performed. For example, the battery control unit 101 of the battery module LFPM performs control to turn off the charge control switch 144a. The battery control unit 101 notifies the control unit 11 that the charging has been stopped. Then, the process proceeds to step S11.

In step S11, a determination is made as to whether or not the other battery module (which in this example is the battery module LIBM) needs to be charged. The process ends in a case where the battery module LIBM does not need to be charged. In a case where the battery module LIBM needs to be charged, the process returns to step S3.

In step S3, the battery module LIBM is set as the battery module that is the charging target. Then, the process proceeds to step S4. Since the battery module that is the charging target is the battery module LIBM, the process proceeds to step S8 following the determination process of step S4.

In step S8, the charge control is started in the battery module LIBM, and the charging of the battery module LIBM is conducted. For example, the battery control unit 201 of the battery module LIBM turns on the charge control switch 244a, and turns off the discharge control switch 245a. Then, the process proceeds to step S9. Notably, the charging is conducted, for example, by the CC (constant current)-CV (constant voltage) method.

Monitoring of the voltages of the nine pieces of battery cells LIB is performed during the charging. In step S9, the battery control unit 201 determines whether or not the maximum voltage among the voltages of the nine pieces of battery cells LIB has reached a terminating voltage (for example, 3.7 V, SOC 60%). As a result of the determination, in a case where the maximum voltage among the voltages of the nine pieces of battery cells LIB has not reached the terminating voltage, the process returns to step S9, and the determination of step S9 is repeated. As a result of the determination, in a case where the maximum voltage among the voltages of the nine pieces of battery cells LIB has reached the terminating voltage, the process proceeds to step S10.

In step S10, control to stop the charging is performed. For example, the battery control unit 201 of the battery module LIBM performs control to turn off the charge control switch 244a. The battery control unit 201 notifies the control unit 11 that the charging has been stopped. Then, the process proceeds to step S11.

In step S11, a determination is made that the charging of the other battery module (which is in this example the battery module LFPM) is completed, and the process ends.

Notably, a program for realizing the aforementioned charge control may be installed, for example, in each of the storing unit 142 of the battery module LFPM and the storing unit 242 of the battery module LIBM.

Notably, in order to prevent deterioration of the battery module LIBM, the charging current for charging the battery module LIBM may be set to a low current at a predetermined value or less. For example, the charging current for charging the battery module LIBM may be set to be smaller than the charging current for charging the battery module LFPM. Further, the charging may be conducted such that the low current is used at an initial stage of the charging.

A time until when the charging of the battery module LFPM is completed (charging time) may be calculated based on the SOC of the battery module LFPM to predict the charging time. Further, a charging time of the battery module LIBM may be calculated based on the SOC of the battery module LIBM to predict the charging time. These processes are, for example, performed by the battery control units of the respective battery module.

For example, a predicted charging time of the battery module LFPM obtained by calculation is set to Tp (min), and a predicted charging time of the battery module LIBM obtained by calculation is set to Ti (min). In a case of charging both battery modules in parallel at the same charging speed (for example, 1C charge), a total charging time becomes Tp since the battery module LFPM is configured to be used regularly. Thus, the charging current amount of the battery module LIBM is set such that a predetermined charging amount is reached by multiplying the charging current amount of the battery module LIBM by Ti/Tp, or before Tp minutes elapses.

For example, it is supposed that 45 minutes of charging time is necessary when the battery module LFPM is charged for a predetermined charging current amount. On the other hand, it is supposed that 15 minutes of charging time is necessary when the battery module LIBM is charged for a suitable charging current amount. The entire charging time (time until when the charging of both battery modules is completed) becomes 45 minutes.

Here, even if the charging of the battery module LIBM is completed after 15 minutes, the charging as a whole is not completed since the charging of the battery module LFPM is not completed. Thus, the charging current amount of the battery module LIBM is deliberately set low at 1/3 (15/45), and the battery module LIBM is charged by the low current. Accordingly, the charging time of the battery module LIBM also becomes 45 minutes, and the charging of both battery modules can be completed at the same time, or substantially at the same time. Moreover, since the charging is performed on the battery module LIBM using the low current, progression of the deterioration of the battery module LIBM accompanying (rapid) charging can be prevented.

Notably, the process to set the charging current amount of the battery module LIBM is performed, for example, by the control unit 11. The control unit 11 sets the charging current amount of the battery module LIBM according to the predicted charging times supplied from the battery control units of the respective battery modules. Further, the control unit 11 instructs the battery control unit 201 of the battery module LIBM to perform charging based on the set charging current amount. The instructed battery control unit 201 performs the control to conduct charging by the instructed charging current amount.

Notably, the control unit 11 may calculate the predicted charging times instead of the battery control units of the respective battery modules. Further, the battery control unit 201 may receive the predicted charging time of the battery module LFPM from the battery control unit 101. Further, the battery control unit 201 may set the charging current amount based on the predicted charging time of the battery module LIBM that is calculated and the predicted charging time of the battery module LFPM that is received. Notably, the charging current amounts may be defined by a charging rate (C (Capacity) rate).

### 2. Variations

Hereinabove, one embodiment of the present disclosure was described specifically, however, the present disclosure is not limited to the above embodiment, and various modifications based on the technical concept of the present disclosure can be made.

The configuration of the battery module (such as a number of battery cells and the like) and the use range can suitably be changed. For example, as shown in FIG. 10, the use range of the battery cells LFP may be set to 2.5 V to 3.6 V (5% to 100% under the denotation of the SOC), and the use range of the battery module LFPM may be set to 30.0 V to 43.2 V. Further, the use range of the battery cells LIB may be set to 3.3 V to 4.0 V (5% to 92% under the denotation of the SOC), and the use range of the battery module LFPM may be set to 29.7 V to 36.0 V. In this case, although an increase in the number of times of repeating charge/discharge of the battery module LIBM may not be expected so much, a function to support an output of the battery module LIBM when an output of the battery module LFPM is decreased can be improved.

Accordingly, by adjusting the SOC level of the battery module LIBM, the life of the battery module LIBM can be lengthened or shortened, however, a various types of use can be provided, such as enabling easy output. For example, by switching how to use the batteries by a button (drawings omitted), a user can set a use mode such as battery-saving use, normal use, power use and the like.

As shown in FIG. 11, the control related to the battery cell unit 102 and the battery cell unit 202 (remaining capacity management, charge/discharge management and the like) may be performed by a common battery control unit 301. Preferably, electric power is supplied to the battery control unit 301 from the battery cell unit 102. Because of this, decrease in the capacity of the battery cell unit 202 can be prevented, and the charging times of the battery cell unit 202 can be prevented from increasing.

The use ranges of the battery cells and the battery modules may be defined by parameters other than voltage and SOC (for example, DOD (Depth Of Discharge). The use ranges of the battery module LIBM and the battery module LFPM may be configured to be set. For example, the use ranges of the battery module LIBM and the battery module LFPM may be configured to be set by an operation of a button by a user and the like. One of an upper limit and a lower limit of the use range may be configured to be set.

A battery apparatus in one embodiment is, for example, a laptop computer, a cell phone, a cordless extension phone, a video movie, a liquid crystal television, an electric shaver, a portable radio, a headphone stereo, a backup power source, an electronic device such as a memory card and the like, a medical apparatus such as a pacemaker and a hearing aid, an electric tool, a drive power source of an electric vehicle (including a hybrid vehicle), an electric power storage power source and the like.

The present disclosure is not limited to a device, but may be realized by a method, program, system, and the like. For example, the present disclosure may be realized as a method of using the battery apparatus. As a subject that implements the method of using the battery apparatus, an electric vehicle in one embodiment, and an electronic device as exemplified may be employed. The program may be provided to the user, for example, via a network, or via a portable memory such as an optical disk, or a semiconductor memory.

Notably, the configurations and processes in the embodiment and the variations can be combined suitably within a range by which no technical inconsistency is generated. Orders of the respective processes in flows of the exemplified processes can suitably be changed within a range by which no technical inconsistency is generated.

The present disclosure may be adapted to a so-called cloud system in which the exemplified processes are divided and performed by a plurality of devices. The present disclosure may be implemented as a system in which the processes exemplified in the embodiment and the variations are executed, and a device by which at least part of the exemplified processes is executed.

The present technique may also be embodied in the structures described below.

(1)

A battery apparatus including:

a first battery module and a second battery module that are connected in parallel and have different characteristics,

wherein a maximum output voltage of the first battery module is set to be larger than a maximum output voltage of the second battery module, and

a use range of the first battery module is set to differ from a use range of the second battery module.

(2)

The battery apparatus according to (1), wherein the first battery module and the second battery module are connected in parallel via a diode.

(3)

The battery apparatus according to (1) or (2), wherein a number of times of repeating charge/discharge of the first battery module is larger than the number of times of repeating charge/discharge of the second battery module.

(4)

The battery apparatus according to any one of (1) to (3), wherein at least one of an upper limit and a lower limit of the use range of the second battery module can be set.

(5)

The battery apparatus according to any one of (1) to (4), wherein the second battery module is charged by a charging current that is smaller than a charging current for the first battery module.

(6)

The battery apparatus according to any one of (1) to (4), wherein a charging current amount for the second battery module is set based on an expected charging time of the first battery module and an expected charging time of the second battery module.

(7)

The battery apparatus according to any one of (1) to (6), wherein the first battery module includes a first battery cell unit configured of one or a plurality of first battery cells, and the second battery module includes a second battery cell unit configured of one or a plurality of second battery cells.

(8)

The battery apparatus according to (7), wherein the first battery cell includes an olivine-type lithium iron phosphate compound as a positive electrode material, and the second battery cell includes a ternary system active material as a positive electrode material.

(9)

The battery apparatus according to (7) or (8), wherein control of the first battery cell unit and the second battery cell unit is configured to be performed by a common battery control unit.

(10)

The battery apparatus according to (9), wherein electric power is configured to be supplied to the battery control unit from the first battery cell unit.

(11)

An electric vehicle including:

a battery apparatus including

a first battery module and a second battery module that are connected in parallel and have different characteristics,

wherein a maximum output voltage of the first battery module is set to be larger than a maximum output voltage of the second battery module, and a use range of the first battery module is set to differ from a use range of the second battery module; and

a drive unit to which electric power is supplied at least from one of the first battery module and the second battery module.

(12)

A battery apparatus including:

a first battery module and a second battery module that are connected in parallel and have different characteristics,

wherein a first maximum output voltage of the first battery module is set to be larger than a second maximum output voltage of the second battery module, and

a first use range of the first battery module is set to differ from a second use range of the second battery module.

(13)

The battery apparatus according to (12), wherein the first battery module and the second battery module are connected in parallel via a diode.

(14)

The battery apparatus according to (12) or (13), wherein a first number of times of repeating charge/discharge of the first battery module is larger than a second number of times of repeating charge/discharge of the second battery module.

(15)

The battery apparatus according to any one of (12) to (14), wherein at least one of an upper limit and a lower limit of the second use range of the second battery module is set.

(16)

The battery apparatus according to any one of (12) to (15), wherein the second battery module is configured to be charged by a second charging current that is smaller than a first charging current for the first battery module.

(17)

The battery apparatus according to any one of (12) to (15), wherein a second charging current amount for the second battery module is set based on an expected first charging time of the first battery module and an expected second charging time of the second battery module.

(18)

The battery apparatus according to any one of (12) to (17), wherein the first battery module comprises a first battery cell unit including one or a plurality of first battery cells, and the second battery module includes a second battery cell unit including one or a plurality of second battery cells.

(19)

The battery apparatus according to (18), wherein the first battery cell includes a first positive electrode material including an olivine-type lithium iron phosphate compound, and the second battery cell includes a second positive electrode material including a ternary system active material.

(20)

The battery apparatus according to (18) or (19), wherein the battery apparatus further includes a common battery control configured to control the first battery cell unit and the second battery cell unit.

(21)

The battery apparatus according to (20), wherein the battery apparatus is configured to supply electric power to the battery control unit from the first battery cell unit.

(22)

An electric vehicle comprising:

a battery apparatus including

a first battery module and a second battery module that are connected in parallel and have different characteristics, wherein a first maximum output voltage of the first battery module is set to be larger than a second maximum output voltage of the second battery module, and a first use range of the first battery module is set to differ from a second use range of the second battery module; and

a drive unit to which electric power is supplied at least from one of the first battery module and the second battery module.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 ELECTRIC VEHICLE
11 CONTROL UNIT
13 POWER OF
13a, 13b DIODE
14 DRIVE UNIT
101 (FIRST) BATTERY CONTROL UNIT
102 (FIRST) BATTERY CELL UNIT
201 (SECOND) BATTERY CONTROL UNIT
202 (SECOND) BATTERY CELL UNIT
LFPM (FIRST) BATTERY MODULE
LIBM (SECOND) BATTERY MODULE

What is claimed is:

1. A battery pack comprising:
a first battery module and a second battery module that are connected in parallel and having different characteristics,
wherein a maximum output voltage of the first battery module is set to be larger than a maximum output voltage of the second battery module, and
a use range of the first battery module is set to differ from a use range of the second battery module.

2. The battery pack according to claim 1, wherein the first battery module and the second battery module are connected in parallel via a diode.

3. The battery pack according to claim 1, wherein a number of times of repeating charge/discharge of the first battery module is larger than a number of times of repeating charge/discharge of the second battery module.

4. The battery pack according to claim 1, wherein at least one of an upper limit and a lower limit of the use range of the second battery module can be set.

5. The battery pack according to claim 1, wherein the second battery module is charged by a charging current that is smaller than a charging current for the first battery module.

6. The battery pack according to claim 1, wherein a charging current amount for the second battery module is set based on an expected charging time of the first battery module and an expected charging time of the second battery module.

7. The battery pack according to claim 1, wherein the first battery module comprises a first battery cell unit configured of one or a plurality of first battery cells, and the second battery module includes a second battery cell unit configured of one or a plurality of second battery cells.

8. The battery pack according to claim 7, wherein the first battery cell comprises an olivine-type lithium iron phosphate compound as a positive electrode material, and the second battery cell includes a ternary system active material as a positive electrode material.

9. The battery pack according to claim 7, wherein control of the first battery cell unit and the second battery cell unit is configured to be performed by a common battery control unit.

10. The battery pack according to claim 9, wherein electric power is configured to be supplied to the battery control unit from the first battery cell unit.

11. An electric vehicle comprising:
a battery pack including
a first battery module and a second battery module that are connected in parallel and have different characteristics, wherein a maximum output voltage of the first battery module is set to be larger than a maximum output voltage of the second battery module, and a use range of the first battery module is set to differ from a use range of the second battery module; and
a drive unit to which electric power is supplied at least from one of the first battery module and the second battery module.
